(19) United States
(12) Patent Application Publication
(10) Pub. No.: US 2026/0177034 A1
(43) Pub. Date: Jun. 25, 2026

(54) MOUNTING SYSTEM, WIND TURBINE, AND METHOD FOR REMOVING A BEARING

(71) Applicants: ZF FRIEDRICHSHAFEN AG, Friedrichshafen (DE); ZF Wind Power Antwerpen N.V., Lommel (BE)

(72) Inventor: Warren SMOOK, Huldenberg (BE)

(21) Appl. No.: 19/422,501

(22) Filed: Dec. 17, 2025

(30) Foreign Application Priority Data
Dec. 20, 2024 (DE) 10 2024 212 232.7

(51) Int. Cl. F03D 13/10; F03D 80/70

(52) U.S. Cl. CPC F03D 13/122; F03D 80/703; F05B 2230/70

(57) ABSTRACT

A mounting system for a drive train of a wind turbine on a nacelle of the wind turbine. The mounting system includes a rotor bearing housing, a stationary component, and a first bearing. The first bearing is mounted in the rotor bearing housing for rotatably supporting a rotor shaft of the drive train. The rotor bearing housing is configured to be mounted to a machine support structure of the nacelle. The mounting system is configured to fix the rotor shaft to the stationary component for removal of the first bearing.

### CROSS REFERENCE TO RELATED APPLICATIONS

This application claims benefit to German Patent Application No. DE 10 2024 212 232.7, filed on December 20, 2024, which is hereby incorporated by reference herein.

### FIELD

The present disclosure relates to a mounting system for a drive train of a wind turbine. Furthermore, the disclosure relates to a wind turbine and a method for removing a bearing.

### BACKGROUND

Wind turbines are used to generate electricity from wind energy. For this purpose, wind turbines have a rotor. A rotational speed of the rotor is transmitted by a rotor shaft to a gearbox. The rotational speed of the rotor shaft is converted by the gearbox into a rotational speed suitable for driving a generator. A drive train of the wind turbine must be supported in the nacelle of the wind turbine. However, this attachment can be very complex and require many parts. In addition, maintenance and replacement of individual components of the drive train can be very costly, depending on the attachment method. For example, it may be necessary to first remove the rotor of the wind turbine before the bearings of a rotor shaft can be replaced. This may require a crane, which is very costly. In the case of offshore wind turbines, for example, a specialized ship must be called in for this purpose, which may only be available after a considerable delay.

### SUMMARY

In an embodiment, the present disclosure provides a mounting system for a drive train of a wind turbine on a nacelle of the wind turbine. The mounting system comprises a rotor bearing housing that is configured to be mounted to a machine support structure of the nacelle. The mounting system also comprises a stationary component, and a first bearing. The first bearing is mounted in the rotor bearing housing for rotatably supporting a rotor shaft of the drive train. The mounting system is configured such that the rotor shaft is fixable to the stationary component for removal of the first bearing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a wind turbine with a drive train;

FIG. 2 is a schematic sectional view illustrating a first embodiment of a mounting system of the drive train for the wind turbine of FIG. 1, with the wind turbine in an operational state;

FIG. 3 is a schematic sectional view illustrating removal of bearings for a rotor shaft in the mounting system shown in FIG. 2;

FIG. 4 is a schematic sectional view illustrating a second embodiment of the mounting system of the drive train for the wind turbine of FIG. 1, with the wind turbine in an operational state;

FIG. 5 is a schematic sectional view illustrating removal of bearings for a rotor shaft in the mounting system shown in FIG. 4;

FIG. 6 is a schematic sectional view illustrating a third embodiment of the mounting system of the drive train for the wind turbine of FIG. 1, with the wind turbine in an operational state;

FIG. 7 is a schematic sectional view illustrating a fourth embodiment of the mounting system of the drive train for the wind turbine of FIG. 1, with the wind turbine in an operational state;

FIG. 8 is a schematic sectional view illustrating a first configuration of the rotor bearing housing in the various embodiments of mounting system;

FIG. 9 is a schematic sectional view illustrating a second configuration of the rotor bearing housing in the various embodiments of mounting system;

FIG. 10 is a schematic illustration of a first variant for releasing an outer ring of a bearing from its seat in the rotor bearing housing by means of a screw in the various embodiments of the mounting system;

FIG. 11 is a schematic illustration of a second variant for releasing the outer ring of the bearing from its seat in the rotor bearing housing by means of a screw in the various embodiments of the mounting system;

FIG. 12 is a schematic illustration of another configuration of the seat of the outer ring of the bearing in the rotor bearing housing in the various embodiments of the mounting system;

FIG. 13 is a schematic side view illustrating a first configuration of the bearing housing in the various embodiments of the mounting system, including at least one through-opening in a circumferential wall;

FIG. 14 is a schematic side view illustrating a second configuration of the through-openings in the circumferential wall of the rotor bearing housing in the various embodiments of the mounting system;

FIG. 15 is a schematic top view illustrating a third configuration of the through-openings in the circumferential wall of the rotor bearing housing in the various embodiments of the mounting system;

FIG. 16 is a schematic side view illustrating a carriage assembly of the mounting system, which is mounted in the rotor bearing housing when the wind turbine is in the non-operational state to allow removal of the first bearing, and which can be used to move the first bearing out of the rotor bearing housing during disassembly;

FIG. 17 is a schematic sectional view of the carriage assembly of the mounting system; and

FIG. 18 is a schematic side view showing the carriage assembly of the mounting system after the bearing has been moved toward an access opening in the rotor bearing housing by means of the carriage assembly.

### DETAILED DESCRIPTION

A first aspect relates to a mounting system for a drive train of a wind turbine on a nacelle of the wind turbine. The nacelle may include a machine support structure. The wind turbine may include a tower on which the nacelle is disposed. The longitudinal extension of the tower extends, for example, in a vertical direction. The nacelle may, for example, be rotatably or non-rotatably mounted on the tower. The nacelle may, for example, be disposed on top of the tower. The tower may, for example, be hollow. The tower may taper toward its upper end. The tower may, for example, be made up of a plurality of stacked tower elements. The tower may, for example, include steel and, alternatively or additionally, concrete as materials.

The drive train may include a rotor shaft, a gearbox, and a generator. In addition, the drive train or the wind turbine may include a rotor. The wind turbine includes the drive train. Components of the drive train may constitute components of the mounting system. The rotor may drive the generator via the gearbox to generate electrical energy. The rotor may be connected to the gearbox via the rotor shaft. The rotor may be supported on the nacelle by the rotor shaft. The rotor, the gearbox, and the generator may be mounted to a nacelle of the wind turbine, for example, together by a main bearing arrangement. The rotor may, for example, have a horizontal or a vertical axis of rotation. The rotor may, for example, have two, three, four, or more rotor blades connected to the rotor shaft via a hub. The drive train may optionally also include a brake.

The mounting system includes a rotor bearing housing. At least one first bearing is mounted in the rotor bearing housing for rotatably supporting the rotor shaft of the drive train. It is also possible that a second bearing may be disposed in the rotor bearing housing for rotatably supporting the rotor shaft. If only the first bearing is provided, the rotor shaft may be supported via a further bearing in another component of the drive train, such as in a gearbox housing or a generator housing. This bearing may also be referred to as second bearing. If two bearings are provided in the rotor bearing housing, the mounting system and the drive train may be free of further bearings for the rotor shaft in other components of the drive train. The bearings may, for example, take the form of rolling-element bearings. Suitable bearings are, for example, tapered roller bearings. The bearings may include an outer ring and an inner ring as well as rolling elements disposed radially therebetween. The inner ring of at least the first bearing may be fitted on the rotor shaft. The outer ring of at least the first bearing may be mounted in a seat on the rotor shaft housing on the inner side thereof. The inner ring and, alternatively or additionally, the outer ring may be secured by a press fit. Alternatively or additionally, axial securement may be provided, for example, by a clamping element for mounting the respective rings. The rotor bearing housing may, for example, be a cast or forged part. The rotor bearing housing may be of single- or multi-part construction.

The rotor bearing housing is configured to be mounted to the machine support structure of the nacelle. The machine support structure may, for example, be a forged or cast part. The machine support structure may have interfaces for attachment of the drive train, such as support surfaces for the rotor bearing housing. The rotor bearing housing may be a separate component from the machine support structure or may be formed integrally with the machine support structure. The rotor bearing housing may, for example, be screwed or riveted to the machine support structure.

The rotor bearing housing and the first bearing as well as the optional second bearing in the rotor bearing housing may form a main bearing arrangement of the drive train. The wind turbine may be free of further bearings via which the drive train is supportable on the machine support structure and overall the nacelle of the wind turbine. The main bearing arrangement may be free of further bearings. The rotor shaft may be supported on the nacelle only via the main bearing arrangement. The gearbox may, for example, also be supported on the nacelle only via the main bearing arrangement. In this case, for example, stationary components of the housing, such as a gearbox housing, are mounted to the rotor bearing housing. However, the gearbox may additionally be supported on the machine support structure, for example, via a spring-damper system or a screw connection of the gearbox housing to the machine support structure. A rotating part of the gearbox, such as an input shaft of the gearbox, may be supported on the two bearings via the rotor shaft. Optionally, the generator may also be supported on the nacelle only via the main bearing arrangement. Alternatively, the generator may additionally be supported on the machine support structure, for example, via a spring-damper system or a screw connection of the gearbox housing to the machine support structure.

The first bearing may be disposed axially in a rotor-side end region of the rotor bearing housing. The first bearing forms, for example, a rotor-side bearing. The second bearing may be disposed axially in a generator-side end region of the rotor bearing housing. The second bearing forms, for example, a generator-side bearing. The two bearings may be axially spaced from each other. The two bearings may be arranged coaxially. In the axial regions in which the two bearings are disposed, the housing may be thickened and, alternatively or additionally, reinforced. The housing may have a closed annular region in the axial regions where the two bearings are located. The axial direction, a radial direction, and a circumferential direction may be defined by the axis of rotation of the rotor shaft and, alternatively or additionally, by the axis of rotation of the respective bearings.

The gearbox may include an input shaft and an output shaft. The gearbox may include a gearbox housing. The generator may include a stator and a rotor. The generator may include a generator housing. The input shaft of the gearbox may be connected to the rotor shaft. The output shaft of the gearbox may be connected to the rotor of the generator. The generator housing may form the stator or the stator may be mounted in the generator housing. The gearbox may include a planetary gear set. A planet carrier may, for example, form the input shaft. A sun gear may, for example, form the output shaft. For example, a ring gear may be mounted in the gearbox housing or may form the gearbox housing.

The mounting system includes a stationary component. The mounting system is configured such that the rotor shaft is fixable to the stationary component for removal of the first bearing. For this purpose, there may be provided fixing means, such as through-holes or blind holes with internal threads in the stationary component and the rotor shaft or a clamping device. The stationary component may be an immovable component which, even without the first bearing, can still bear the loads supported by the first bearing and, optionally, the second bearing on the rotor bearing housing. For example, the stationary component may be the machine support structure, the rotor bearing housing, or another load-bearing component of the nacelle. The rotor shaft may, for example, be temporarily secured to the machine support structure or the rotor bearing housing using fastening means, for example, in the form of screws. In this case, the rotor shaft is, for example, no longer rotatably supported. Then, the drive train is, for example, no longer operational. The connection between the rotor shaft and the stationary component may be configured, for example, to resist all loads which act or may act on the first bearing when the wind turbine is at rest. The fixing means may be accessible when the drive train is in the assembled state. The rotor shaft may, for example, be screwed to a flange of the rotor bearing housing directly or via the hub. The removal of the first bearing may involve removing the first bearing from its bearing seat. The removal of the first bearing may involve removing at least a part of or the entire first bearing from the rotor bearing housing. This allows the first bearing to be replaced and/or serviced. The first bearing may be disassembled during removal or remain in an operational condition.

To remove the first bearing, first, the rotor shaft may be secured. Then, first bearing may be removed from the rotor bearing housing without, for example, having to remove the rotor. The rotor and other components of the drive train may then remain supported on the machine support structure by the rotor bearing housing. To remove the first bearing, it may be necessary to remove the gearbox and, alternatively or additionally, the generator. However, the mounting system may also be configured to allow the first bearing to be pushed through the gearbox and, alternatively or additionally, through the generator for removal.

An embodiment of the mounting system may provide that the stationary component is formed by the rotor bearing housing. Fixing the rotor shaft to the rotor bearing housing can be very simple since the rotor shaft is already disposed adjacent to the rotor bearing housing. In addition, the rotor bearing housing may generally be configured to carry the loads acting on the first bearing, so that no reinforcement is required for mounting the first bearing as compared to a design without the possibility of fixing the rotor shaft. The rotor shaft and the rotor bearing housing may form axially adjacent and radially extending flanges, on which they can be mounted together for removal of the first bearing.

An embodiment of the mounting system may provide that the rotor bearing housing has an access opening. The access opening may be formed at an end opposite the rotor of the wind turbine. For example, the access opening may be formed at an end face of the rotor bearing housing. The access opening may face the gearbox and, alternatively or additionally, the generator. The first bearing may be removable through the access opening during disassembly. For example, the first bearing may be axially pulled out of the rotor bearing housing through the access opening.

The access opening may be an axial through-opening in the rotor bearing housing. The access opening may be closed by a cover. The cover may be removable to allow removal of the first bearing. The cover may form part of the rotor bearing housing or be separate therefrom. The cover may be attached with screws. The cover may form a connecting member via which the generator and, alternatively or additionally, the gearbox are mounted to the rotor bearing housing. The second bearing may be mounted in the cover. The second bearing may be removed by removing the cover or at least during removal of the cover. For example, the second bearing may not be removable until the rotor shaft is fixed to the stationary component. It may be necessary to remove the second bearing before the first bearing can be removed from the access opening. When removing one of the bearings, this bearing may at least be released from its seat. During removal, at least an outer ring of the respective bearing may be released. When removing one of the bearings, the bearing may also be disassembled by releasing the outer ring from an inner ring of the bearing.

As already described, an embodiment of the mounting system may provide that the mounting system includes the second bearing. The second bearing may be disposed on a side opposite the rotor next to the first bearing, for example, axially spaced from the first bearing. The second bearing may be fitted on the rotor shaft. The second bearing may also be removable through the access opening for removal thereof. The removal may be accomplished by clearing the access opening by removing the cover.

An embodiment of the mounting system may provide that a radial clearance between the rotor shaft and the rotor bearing housing widens in an axial direction toward the end opposite the rotor. A space between an exterior surface of the rotor shaft and an interior surface of the rotor bearing housing may increase in the axial direction away from the rotor and, alternatively or additionally, toward the access opening. This may facilitate removal of the first bearing. For example, the first bearing can thus be easily moved along the rotor shaft toward the access opening. The radial clearance between the rotor shaft and the rotor bearing housing may increase monotonically from the seat of the first bearing to the access opening. For example, the radial clearance between the rotor shaft and the rotor bearing housing does not decrease axially in any axial region from the seat of the first bearing toward the access opening. The radial clearance between the rotor shaft and the rotor bearing housing may widen continuously, for example conically, or in a stepped manner.

The radial clearance between the rotor shaft and the rotor bearing housing may increase, for example, because an inner diameter of the rotor bearing housing widens in the axial direction toward the end of the rotor bearing housing opposite the rotor. Due to the widening, the inner diameter may increase. The inner diameter may widen toward the access opening from a seat of the first bearing. The inner diameter may increase monotonically from the seat of the first bearing to the access opening. For example, the inner diameter does not decrease axially in any axial region from the seat of the first bearing toward the access opening. The inner diameter may widen continuously, for example conically, or in a stepped manner. However, the rotor bearing housing may also have a constant inner diameter between the seat of the first bearing and the access opening.

Alternatively or additionally, the radial clearance between the rotor shaft and the rotor bearing housing may increase because an outer diameter of the rotor shaft tapers in the axial direction toward the end of the rotor bearing housing opposite the rotor. Due to the taper, the outer diameter may decrease. The outer diameter may taper toward the access opening from the seat of the first bearing. The outer diameter may decrease monotonically from the seat of the first bearing to the access opening. For example, the outer diameter does not increase axially in any axial region from the seat of the first bearing toward the access opening. The outer diameter may taper continuously, for example conically, or in a stepped manner. However, the rotor shaft may also have a constant outer diameter between the seat of the first bearing and the access opening.

An embodiment of the mounting system may provide that the mounting system includes a carriage assembly. The carriage assembly may be mountable in the rotor bearing housing. The carriage assembly may, for example, include a guide rail, which is mountable to the rotor bearing housing, for example, by a screw connection. The carriage assembly may, for example, be mountable only after the access opening has been cleared and, alternatively or additionally, after the second bearing has been removed. When the carriage assembly is mounted, the wind turbine may not be operational. The first bearing may be movable out of the rotor bearing housing by means of the carriage assembly during disassembly. The carriage assembly may include a carriage, which is, for example, held on the guide rail in such a way that it is translationally movable in the axial direction. The first bearing may be attachable to the carriage assembly, for example, to the carriage thereof. The carriage assembly may hold the first bearing while it is moved axially through the rotor bearing housing for removal. The carriage assembly may hold, for example, only the outer ring of the first bearing or the entire first bearing. The carriage assembly may also be used to first remove the outer ring of the first bearing from the rotor bearing housing and then to remove the remainder of the first bearing. The carriage assembly may have a drive. The drive of the carriage assembly may also be provided by the wind turbine. Preferably, the carriage assembly is connectable to a motor-driven device, for example, to a crane installed in the nacelle of the wind turbine, in order to drive the carriage assembly. The carriage assembly, or at least the mounting system, may, for example include one or more pulleys for this purpose. This allows the first bearing to be moved in a controlled manner even when the axis of rotation of the rotor shaft is inclined relative to a horizontal. Using the carriage, it is possible to remove even the extremely heavy first bearings of large wind turbines, which can, for example, weigh several tons. In addition, the carriage assembly may facilitate removal in cases where an interior space in the rotor bearing housing is, for example, too confined for a technician to access the first bearing. The second bearing may be disposed, for example, directly at the end region of the rotor bearing housing opposite the rotor and may thus be removable without the carriage assembly. However, the second bearing may also be carried by the carriage assembly during disassembly, for example, to a location spaced apart from the rotor bearing housing.

An embodiment of the mounting system may provide that the mounting system is configured to release an outer ring of the first bearing from its seat in the rotor bearing housing by means of a screw. The screw may exert an axial force on the outer ring to release it from a seat in the rotor bearing housing. The axial force may be applied, for example, by turning the screw within a thread or by turning a nut on the screw. However, the screw cannot be used, for example, to fix the outer ring to the rotor bearing housing. When the wind turbine is in an operational state, the screw is not located in the rotor bearing housing, for example. The mounting system may include a tool set for releasing the outer ring of the first bearing from its seat, the tool set including the screw. For example, a clamping element that fixes the outer ring axially to the rotor bearing housing may be released for disassembly and replaced with a counter-bearing element. The screw is passed through a through-hole in the counter-bearing element and threaded into the outer ring. The outer ring is then axially pulled out of its seat by further threading of, for example, a nut. Subsequently, a pulling element, such as a hook, may be inserted into the same counter-bearing element or a further counter-bearing element, which is then inserted, and may pull the inner ring and, alternatively or additionally, rolling elements of the first bearing out of the seat on the rotor shaft. Alternatively, the outer ring may have a through-hole with an internal thread. The screw may be threaded thereinto and may then bear by its tip against a shoulder of the rotor bearing housing. In this way, the outer ring can also be axially pushed out of its seat.

Alternatively or additionally, the outer ring of the first bearing may be in contact with the rotor bearing housing only over a portion of its outer periphery. For example, a contact surface of the outer ring extends only over a portion of the axial extent of the outer ring. In this case, the outer ring of the first bearing can be released from the seat in the rotor bearing housing with little effort.

An embodiment of the mounting system may provide that the rotor bearing housing has at least one through-opening in a circumferential wall through which the first bearing is accessible for removal. The through-opening may extend radially through the rotor bearing housing. The through-opening may be located adjacent the first bearing. The first bearing may thus be easily accessible for its removal. The through-opening may, for example, allow insertion therethrough of the screw for releasing the outer ring from its seat in the rotor bearing housing. In addition, the first bearing may be released from its attachment from outside the rotor bearing housing through the through-opening. It may also be possible to attach the carriage assembly to the rotor bearing housing and, alternatively or additionally, to the first bearing through the through-opening. A plurality of circumferentially and, alternatively or additionally, axially spaced through-openings may be provided. It is also possible that through-openings may be provided adjacent the second bearing for removal thereof. During operation, the through-openings may be closed by a cap. Alternatively or additionally, the bearings may, for example, also be sealed.

A second aspect relates to a wind turbine that includes the mounting system according to the first aspect. The respective advantages and further features can be inferred from the description of the first aspect. Embodiments of the first aspect also form embodiments of the second inventive aspect and vice versa. The wind turbine includes the nacelle. The nacelle includes the machine support structure. The wind turbine includes the rotor shaft, optionally with the rotor mounted thereto. The wind turbine may include the tower. The rotor bearing housing is mounted to the machine support structure. The rotor shaft is rotatably supported by the first bearing in the rotor bearing housing. The rotor shaft is fixable to a stationary component for removal of the first bearing. The gearbox may be mounted to the machine support structure via the rotor bearing housing. The generator may be mounted to the machine support structure via the rotor bearing housing. The rotor bearing housing and the machine support structure may be formed as separate components.

A third aspect relates to a method for removing a first bearing from a rotor bearing housing of a wind turbine. The method can be used to remove the first bearing in the wind turbine according to the second aspect and, alternatively or additionally, in the mounting system according to the first aspect. The respective advantages and further features can be inferred from the description of the first and second aspects. Embodiments of the first and/or second aspects also form embodiments of the third aspect and vice versa.

In the method, the rotor bearing housing is mounted to a machine support structure in a nacelle of the wind turbine. The first bearing is mounted in the rotor bearing housing, for example, at least at the beginning of the method. A rotor shaft of the wind turbine is rotatably supported by the first bearing on the rotor bearing housing, for example, at least at the beginning of the method.

The method includes a step of fixing the rotor shaft to a stationary component. For this purpose, the rotor shaft is, for example, screwed to the rotor bearing housing as the stationary component. The method includes a step of releasing the attachment of the first bearing after the rotor shaft has been fixed. The first bearing can then be removed from the rotor bearing housing, for example, by moving it axially through the access opening. Releasing may include releasing the first bearing from the rotor bearing housing and, alternatively or additionally, from the rotor shaft. The first bearing may be released from the rotor bearing housing and from the rotor shaft simultaneously or sequentially. For example, first, the outer ring is released from its seat in the rotor bearing housing. It is only then that the inner ring is released from its seat on the rotor shaft. The method may include a step of releasing the gearbox and, alternatively or additionally, moving it away from the rotor bearing housing. The method may include a step of releasing the generator from the gearbox and, alternatively or additionally, moving it away from the gearbox and, alternatively or additionally, from the rotor bearing housing. The generator may be released and moved away together with the gearbox. The method may include a step of opening the access opening in the rotor bearing housing. The method may include a step of releasing the second bearing and, alternatively or additionally, removing it, for example, from the rotor bearing housing. The method may include a step of installing the carriage assembly. The method may include a step of attaching the first bearing to the carriage of the carriage assembly. The method may include a step of removing the first bearing from the rotor bearing housing, for example, by means of the carriage assembly.

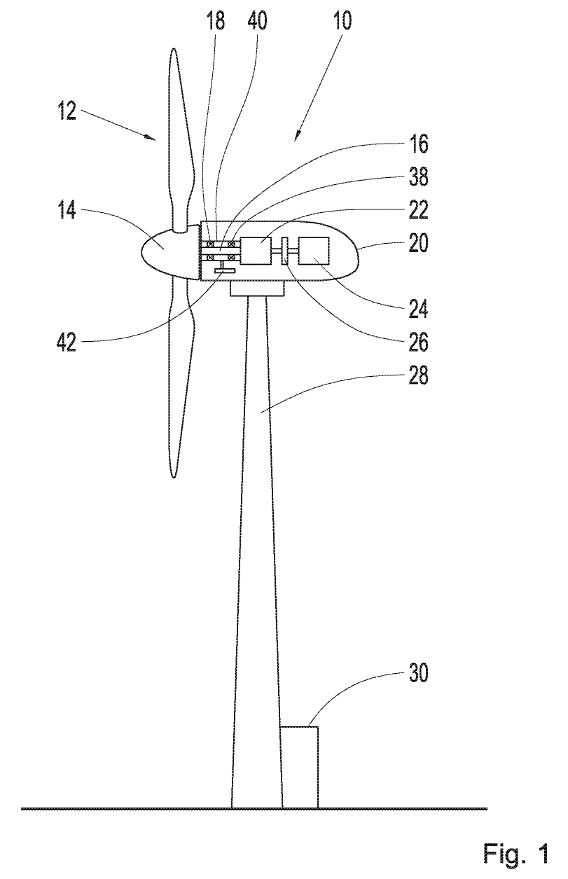

FIG. 1 illustrates a horizontal-type wind turbine 10 including a drive train. Wind turbine 10 includes a rotor 12, which is held to a rotor shaft 16 via a hub14. The axis of rotation of rotor shaft 16 extends substantially horizontally. Rotor shaft 16 is supported in a nacelle 20 via two rolling-element bearings 18, 38. For this purpose, there is provided a rotor bearing housing 40, which is mounted to a machine support structure 42 of nacelle 20. Rotor shaft 16 is mechanically operatively connected to a generator 24 via a gearbox 22. In addition, a brake 26 is disposed in the operative connection between gearbox 22 and generator 24, the brake acting on an input shaft of generator 24. Nacelle 20 is rotatably mounted on a top end of a tower 28, which is anchored to the ground. In another embodiment, wind turbine 10 is designed as an offshore system. Wind turbine 10 has a grid connection 30 next to tower 28. A first of the bearings, 18, faces rotor 12 and is also referred to as rotor-side bearing 18. A second of the bearings, 38, faces generator 24 and is also referred to as generator-side bearing 38. The two bearings 18, are here configured as tapered roller bearings. At least rotor bearing housing 40, rotor shaft 16, rotor 12, gearbox 22, and generator 24 form components of the drive train of wind turbine 10.

In the illustration of FIG. 1, gearbox 22 is disposed axially between rotor bearing housing 40 and generator 24. Both generator 24 and gearbox 22 are mounted to machine support structure 42 solely via rotor bearing housing 40. Generator 24 is connected to rotor bearing housing 40 indirectly via gearbox 22 and thus mounted to machine support structure 42 via both gearbox 22 and rotor bearing housing 40. Rotor 12 is also supported solely on machine support structure 42 via rotor shaft 16 and the main bearing arrangement. Therefore, it may be necessary to remove rotor 12 if the two bearings 18, 38 are to be replaced or serviced.

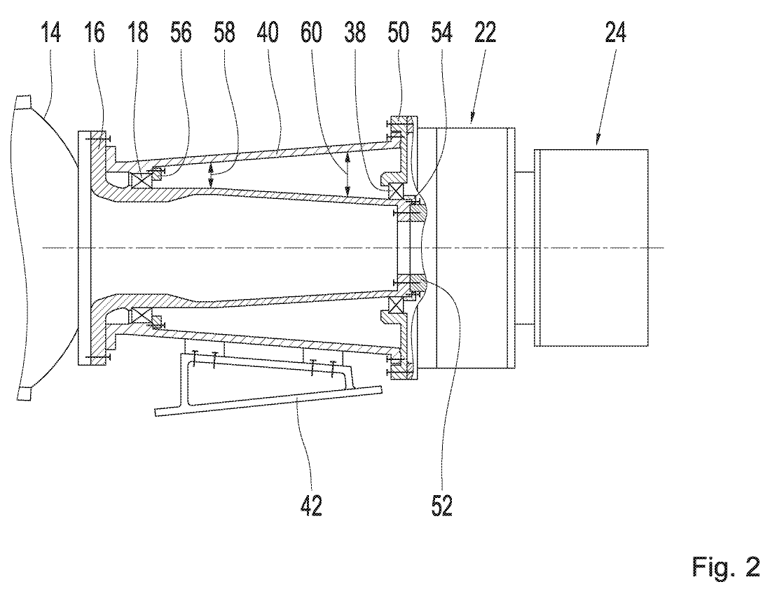

FIG. 2 illustrates in a sectional view a first embodiment of a mounting system for mounting the drive train of wind turbine 10 of FIG. 1 to the nacelle of wind turbine 10. The mounting system includes rotor bearing housing 40 and the two bearings 18, 38. First bearing 18 is located in rotor bearing housing 40. Second bearing 38 is located in a cover 50 and is thus indirectly mounted in rotor bearing housing 40. Cover 50 closes an access opening at an end of rotor bearing housing 40 opposite rotor 12. Cover 50 is screwed to the rotor bearing housing at an end face thereof. By releasing cover 50, second bearing 38 is released from rotor bearing housing 40, and when removing cover 50, is also automatically removed from an interior of rotor bearing housing 40. Gearbox 22 is screwed to cover 50 by its housing. Generator 24 is mounted by its housing to the housing of gearbox 22 and is thereby indirectly connected to cover 50 and thus to rotor bearing housing 40. An input shaft 52 of gearbox 22 is screwed to rotor shaft 16, so that, during operation, a driving force can be transmitted from rotor 12 to gearbox 22. FIG. 2 shows the mounting system, and thus also wind turbine 10, in an operational state.

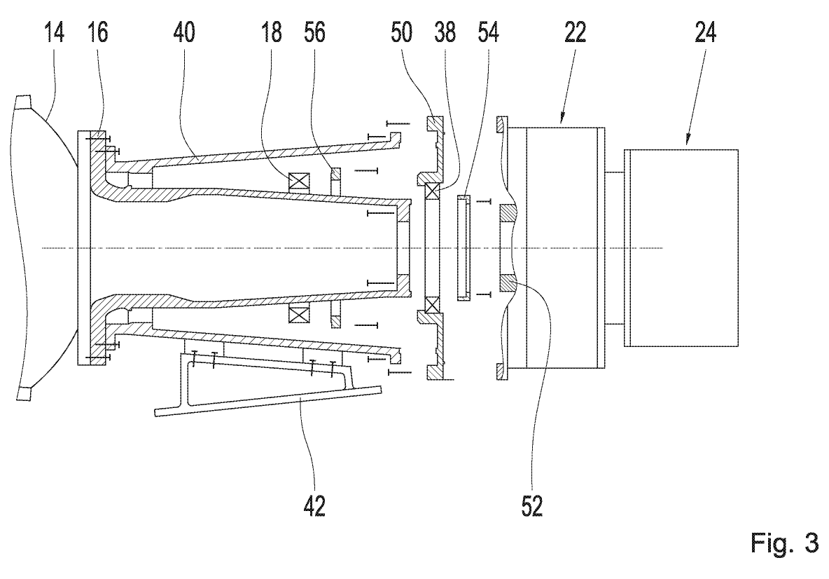

FIG. 3 illustrates in a sectional view the removal of the two bearings 18, 38 in the first embodiment of the mounting system. Rotor 12 does not need to be removed for this purpose. Instead, the mounting system is configured to fix rotor shaft 16 to a stationary component of the mounting system for removal of first bearing 18 and of second bearing 38. In the present case, rotor bearing housing 40 forms the stationary component. As can be seen in FIG. 3, in order to remove the two bearings 18, 38, rotor shaft 16 is first screwed at an end face to rotor bearing housing 40 at a rotor-side end region by a screw connection at two adjacent and radially projecting flanges of rotor bearing housing 40 and rotor shaft 16. In this way, rotor shaft 16 is temporarily fixed and wind turbine 10 is no longer operational. Nevertheless, loads which were previously introduced into rotor bearing housing 40 via the two bearings 18, 38, respectively, can now be transmitted via this screw connection. Rotor bearing housing 40 then continues to transfer these forces into machine support structure 42.

To remove the two bearings 18, 38, first, gearbox 22 and generator 24 are released from the remainder of the drive train. For this purpose, the screw connection between the housing of gearbox 22 and cover 50 and the screw connection between input shaft 52 and rotor shaft 16 are released. In the example shown, input shaft 52 is configured as a planet carrier of a planetary gear set of gearbox 22. The screw connection between input shaft 52 and rotor shaft 16 is accessible from the outside for this purpose. Then, gearbox 22 and generator 24 are moved away from rotor bearing housing 40, for example, by a crane integrated in nacelle 20 of wind turbine 10 or using rails temporarily installed in nacelle 20. Subsequently, a fixing element 54, which locks second bearing 38 axially in position during operation, is released. The fixing element 54 is configured here as a clamping ring which, in the operational state, is screwed to rotor shaft 16. Then, cover 50, together with second bearing 38 located therein, is released from rotor bearing housing 40 and axially moved away to clear the access opening at the gearbox-side end of rotor bearing housing 40 opposite rotor 12. This access opening is configured here as an axial through-opening. Alternatively, it is also possible to fist remove only second bearing 38 and only then remove cover 50. Again, the respective components are moved away by the crane integrated in nacelle 20.

After the access opening has been cleared, a further fixing element 56, which locks first bearing 18 axially in position during operation, is released. Further fixing element 56 is configured here as a clamping ring which, in the operational state, is screwed to rotor bearing housing 40. First bearing 18 can then be moved axially along rotor shaft 16 toward the access opening and then removed from the interior of rotor bearing housing 40 through the access opening. This allows first bearing 18 to be replaced and serviced without having to remove rotor 12. In the example shown, assembly is performed in reverse order.

To facilitate movement of first bearing 18 from its seat to the access opening, a radial clearance between rotor shaft 16 and rotor bearing housing 40 widens in an axial direction toward the end opposite rotor 12 and thus toward the access opening. A distance between an outer periphery of rotor shaft 16 and an inner periphery of rotor bearing housing 40 thus increases from the seat of first bearing 18 toward the access opening. For the sake of clarity, this is illustrated only in FIG. 2 by the two arrows 58, 60. Arrow 60, which is closer to the access opening than arrow 58, is therefore longer than arrow 58.

To this end, in the embodiment shown, an outer diameter of rotor shaft 16 decreases continuously from the seat of first bearing 18 to the access opening. To this end, the outer wall of rotor shaft 16 slopes at a constant angle radially inwardly and rotor shaft 16 thus tapers conically in the axial direction toward the access opening. Also for this purpose, an inner diameter of rotor bearing housing 40 increases continuously from the seat of first bearing 18 toward the access opening, and the rotor bearing housing thus widens conically. To this end, the inner wall of rotor bearing housing 40 slopes at a constant angle radially outwardly in the axial direction toward the access opening. In the figures and embodiments shown here, the widening of the radial clearance between rotor shaft 16 and rotor bearing housing 40 in the axial direction toward the access opening is shown exaggerated for purposes of illustration. In an actual implementation, the increase may be a few millimeters or centimeters. Accordingly, the slope of the inner wall of rotor bearing housing 40 and of the outer wall of rotor shaft 16 is then much smaller than shown here.

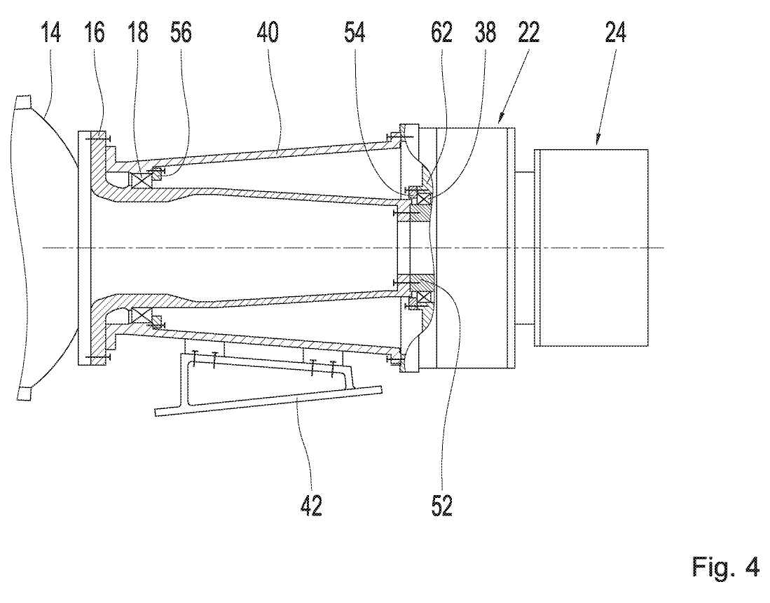

FIG. 4 shows a second embodiment of the mounting system, which is similar to the first embodiment. Only differences will be described. Cover 50 is omitted here. Instead, the housing of gearbox 22 is screwed directly to rotor bearing housing 40 and thus closes the access opening. Moreover, second bearing 38 is not located in rotor bearing housing 40 on cover 50, which is not present here. Instead, second bearing 38 is mounted on a non-rotating component 62 of gearbox 22 by means of fixing element 54. Non-rotating component 62 is configured as a bearing seat for second bearing 38 and is fixed to the housing of gearbox 22. In other embodiments, non-rotating component 62 is formed by the housing. Input shaft 52 is rotatably supported in second bearing 38. Rotor shaft 16 is thus rotatably supported on second bearing 38 indirectly via input shaft 52.

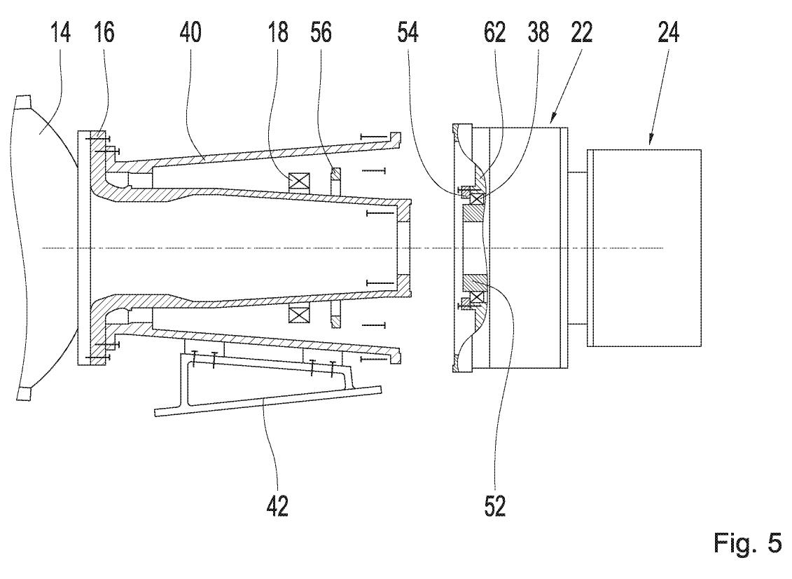

During removal of first bearing 18, the access opening in rotor bearing housing 40 is now cleared directly by releasing gearbox 22 and moving it away, as shown in FIG. 5. Second bearing 38 can remain mounted in gearbox 22 and fixing element 54 does not need to be released. In this way, input shaft 52 remains supported, and thus gearbox 22 remains in an operational state. This allows testing of gearbox 22 and generator 24 in the released state. In addition, input shaft 52 does not need to be secured for transport and gearbox 22 can remain sealed. In the second embodiment, fewer screw connections have to be released and fewer parts have to be handled during removal of first bearing 18. In contrast, when removing first bearing 18 in the first embodiment, the respective parts to be handled may have a lower weight. In addition, the two bearings 18, 38 can be more easily and precisely aligned coaxially with each other.

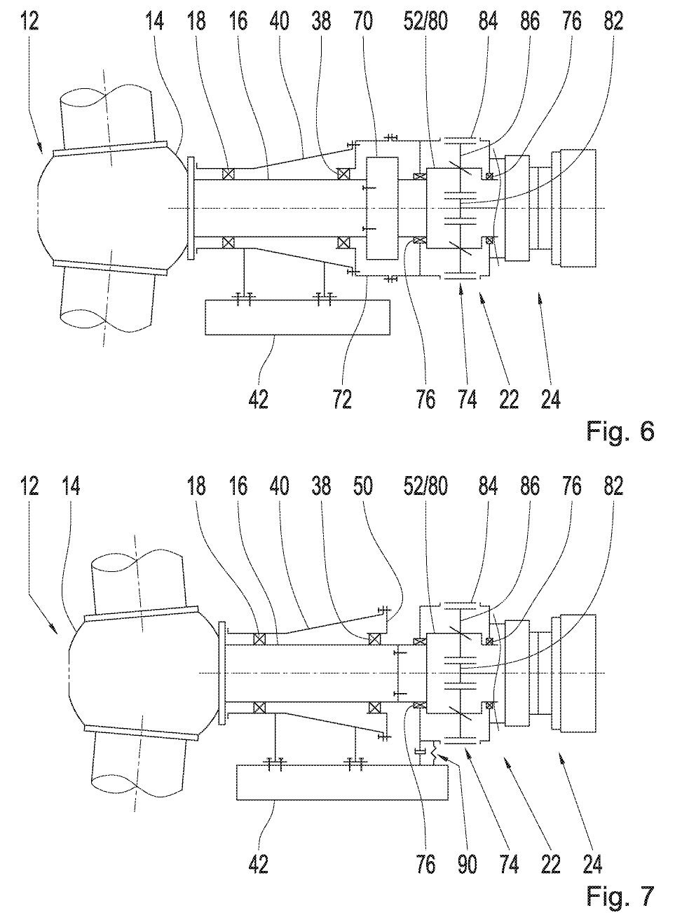

In FIG. 6, a third embodiment of the mounting system, which is a modification of the first embodiment, is shown with wind turbine,10 in an operational state. Only differences described will be described. The drive train now has an elastic connecting element 70, which connects rotor shaft 16 to input shaft 52 of gearbox 22. Therefore, input shaft 52 is no longer rigidly screwed directly to rotor shaft 16. A housing element 72 which accommodates connecting element 70 therein is disposed radially outwardly relative to connecting element 70. Housing element 72 closes the access opening of rotor bearing housing 40, as cover 50 does in the first embodiment. Second bearing 38 is mounted to housing element 72 similarly to cover 50 in the first embodiment. The housing of gearbox 22 is non-rotatably connected to rotor bearing housing 40 via housing element 72 by means of corresponding screw connections.

FIG. 6 further shows planetary gear set 74 of gearbox 22. Input shaft 52 is formed by planet carrier 80, which is additionally rotatably supported on the housing of gearbox 22 by two rolling bearings 76 of gearbox 22. Due to the elastic connecting element 70, the mounting arrangement is not overconstrained. Planetary gear set 74 further includes a sun gear 82 and a ring gear 84. Ring gear 84 is mounted to the housing of the gearbox. Sun gear 82 forms the output shaft of gearbox 22, which is mounted to a rotor of generator 24. A plurality of planet gears 86 are rotatably mounted on planet carrier 80. Planet gears 86 each mesh with ring gear 84 and sun gear 82. In other embodiments, gearbox 22 includes further planetary gear sets.

In the embodiment of FIG. 6, the outer diameter of rotor shaft 16 does not taper from the seat of first bearing 18 to the access opening. Instead, rotor shaft 16 has a constant outer diameter. Due to the widening of the inner diameter of rotor bearing housing 40, the radial clearance between rotor shaft 16 and rotor bearing housing 40 nevertheless widens toward the access opening.

In the third embodiment of the mounting arrangement, the removal of first bearing 18 is carried out analogously to the first embodiment, which is illustrated for the first embodiment in FIG. 3. Here, housing element 72 is released instead of cover 50 in order to clear the access opening in rotor bearing housing 40. To release gearbox 22, connecting element 70 is released, which can remain on input shaft 52 of gearbox 22.

In FIG. 7, a fourth embodiment of the mounting system, which is a modification of the first embodiment, is shown with wind turbine 10 in an operational state. Also shown is the internal structure of gearbox 22, which is configured as in the third embodiment of FIG. 6. Rotor shaft 16 is also configured as in the third embodiment and thus formed with a constant outer diameter. Only differences will be described.

In the fourth embodiment, gearbox 22 is not mounted to the machine support structure via rotor bearing housing 40. Instead, the housing of gearbox 22 is mounted directly to machine support structure 42 via rubber bushing elements 90. Because gearbox 22 is elastically supported by bushing elements 90 on the machine support structure 42, the mounting arrangement is not over constrained here either, although input shaft 52 of gearbox 22 is rigidly mounted to rotor shaft 16 by a screw connection.

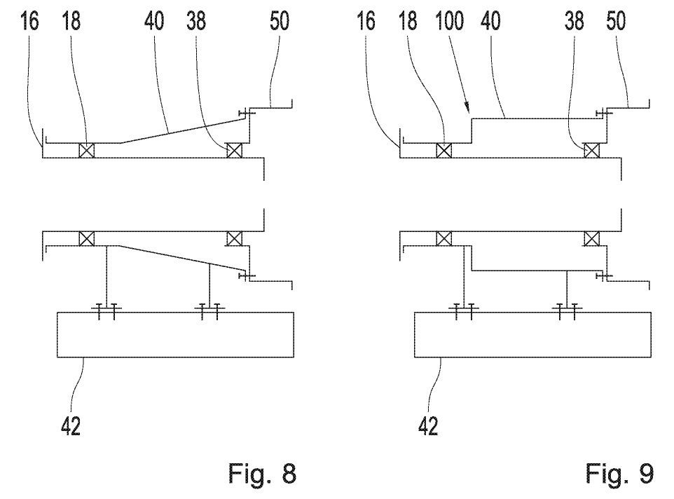

FIG. 8 shows a first variant of rotor bearing housing 40, where the radial clearance between rotor shaft 16 and rotor bearing housing 40 widens in the axial direction toward the access opening because the inner diameter of the rotor bearing housing increases in this direction due to a radially outward slope of the wall. This corresponds to the configuration illustrated in the previously described embodiments. FIG. 9 shows a second variant of rotor bearing housing 40, where the radial clearance between rotor shaft 16 and rotor bearing housing 40 widens in the axial direction toward the access opening because the inner diameter of rotor bearing housing 40 increases once in the direction of the access opening due to a step 100 axially adjacent the seat of first bearing 18. In other embodiments, several such steps 100 are provided. Both design variants of rotor bearing housing 40 for increasing the radial clearance between rotor shaft 16 and rotor bearing housing 40 in the axial direction toward the access opening are combined in further embodiments with any of the embodiments of the mounting system shown, or, generally, with a rotor shaft 16 having a constant outer diameter or an outer diameter that decreases axially in the direction of the access opening. In other embodiments, rotor shaft 16 is configured such that the outer diameter is reduced by one or more steps instead of a radially inward slope of an outer peripheral surface.

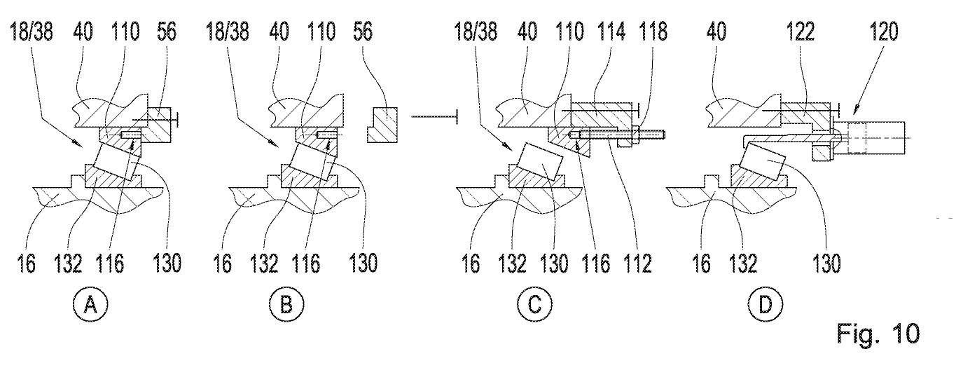

FIG. 10 schematically illustrates a first variant for releasing an outer ring 110 of first bearing 18 and, alternatively or additionally, of second bearing 38 by means of a screw 112 from its seat in rotor bearing housing 40 or another component in the various embodiments of the mounting system. Outer ring 110 is axially fixed by a fixing element, such as fixing element 56. This is shown in subfigure A of FIG. 10. This fixing element 56 is screwed to the component that forms the seat and is removed to release outer ring 110. This is shown in subfigure B of FIG. 10. Then, a counter-bearing element 114 is disposed approximately at the position thereof and attached by a screw connection to the component that forms the seat. This is shown in subfigure C of FIG. 10. Counter-bearing element 114 has a through-hole formed therein which is aligned coaxially with blind hole 116. Screw 112 is passed through the through-hole in counter-bearing element 114 and threadedly connected with the outer ring via blind hole 116. By turning a nut 118 on screw 112, screw 112 is axially withdrawn through the through-hole in counter-bearing element 114. In doing so, outer ring 110 is also pulled axially in a direction toward the access opening. In one design, outer ring 110 is thereby released from the remainder of the bearing. This is shown in subfigure C of FIG. 10. In another design, the entire bearing is pulled axially in a direction toward the access opening.

Subfigure D of FIG. 10 further shows a pulling device 120, which is attached to the component forming the seat via a further counter-bearing element 122 by a screw connection. Pulling device 120 includes an actuator 124 and a hook element 126, which engages with one or more rolling elements 130 of the bearing and thus can pull rolling elements 130 and an inner ring 132 of the bearing axially in a direction toward the access opening. In this way, inner ring 132 is also released from its seat. This is also illustrated in subfigure D.

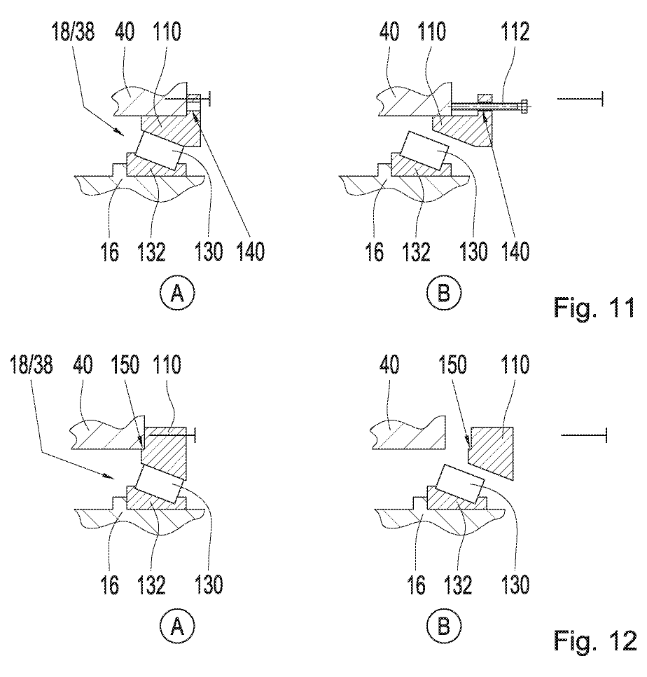

FIG. 11 schematically shows a second variant for releasing outer ring 110 of first bearing 18 and, alternatively or additionally, of second bearing 38 by means of screw 112 from its seat in rotor bearing housing 40 or another component in the various embodiments of the mounting system. Here, outer ring 110 is configured differently and partially extends radially along an end face of the component that forms the seat for outer ring 110. This portion of outer ring 110 has a through-hole 140 with an internal thread. In addition, this portion of outer ring 110 is mounted to the component that forms the seat for outer ring 110 by screwing it to the end face thereof. To release outer ring 110 from its seat, this screw connection is released first. Then, screw 112 is threaded into through-hole 140. In doing so, screw 112 bears against the end face of the component that forms the seat for outer ring 110 and thus pushes outer ring 110 axially in a direction toward the access opening. This is illustrated in subfigure B of FIG. 11. Subfigure A of FIG. 11 in turn shows outer ring 110 mounted in its seat.

FIG. 12 illustrates another configuration of the seat of outer ring 110 of the bearing in a component, such as rotor bearing housing 40, in the various embodiments of the mounting system. Here, too, outer ring 110 is screwed to the end face of the component that forms the seat for outer ring 110 in order to axially fix it in place. This is illustrated in subfigure A of FIG. 12. Outer ring 110 has an outer circumferential wall having a region 150 of small axial extent, which rests radially outwardly in and against the seat in the component. To release outer ring 110, the screw connection is released. Due to the small axial extent of region 150 of the outer circumferential wall, which rests radially outwardly in and against the seat in the component, outer ring 110 can be released with little effort. This is illustrated in subfigure B of FIG. 12.

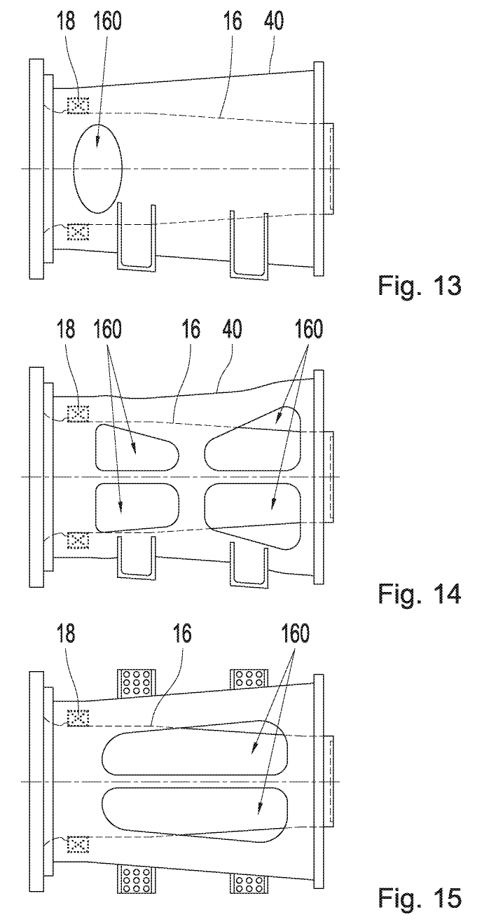

FIG. 13 schematically illustrates in a side view a first configuration of rotor bearing housing 40, which has at least one through-opening 160 in a circumferential wall. This allows access to the interior of rotor bearing housing 40 even when wind turbine 10 is in an operational state. For example, first bearing 18 can be released through the radially extending through-opening 160, as previously described. In addition, a carriage assembly 200 may be installed, which will be described later herein. In the example shown in FIG. 13, through-opening 160 is oval in shape and located in a rotor-side end region. The example shown has two coaxial through-openings 160 on opposite sides, which face substantially in a horizontal direction. Due to the oval shape and the small size and number of through-openings, rotor bearing housing 40 can withstand high loads. In yet another embodiment, rotor bearing housing 40 has additional such through-openings 160 on the underside and, alternatively or additionally, on the upper side.

FIG. 14 schematically illustrates in a side view a second configuration of rotor bearing housing 40, which has at least one through-opening 160 in a circumferential wall. In this configuration, two through-openings 160 are shown adjacent each other in the vertical direction in each of the rotor-side end region and the generator-side end region. The generator-side end region is located in the region of the access opening. The second design also allows easy access to second bearing 38 from the interior of rotor bearing housing 40. The example shown includes through-openings 160 on an opposite side, which are coaxial to the through-openings 160 shown and face substantially in a horizontal direction. In yet another embodiment, rotor bearing housing 40 has additional such through-openings 160 also on the underside and, alternatively or additionally, on the upper side.

FIG. 15 schematically illustrates in a top view a third configuration of rotor bearing housing 40, which has at least one through-opening 160 in a circumferential wall. In this configuration, two through-openings 160 are provided side by side in the transverse direction on the upper and lower side, respectively. In the third configuration, these through-openings 160 extend from the rotor-side end region to the generator-side end region. The third configuration allows easy handling of first bearing 18 from the outside through the circumferential wall of rotor bearing housing 40 when moving first bearing 18 to the access opening for removal from rotor bearing housing 40 during disassembly.

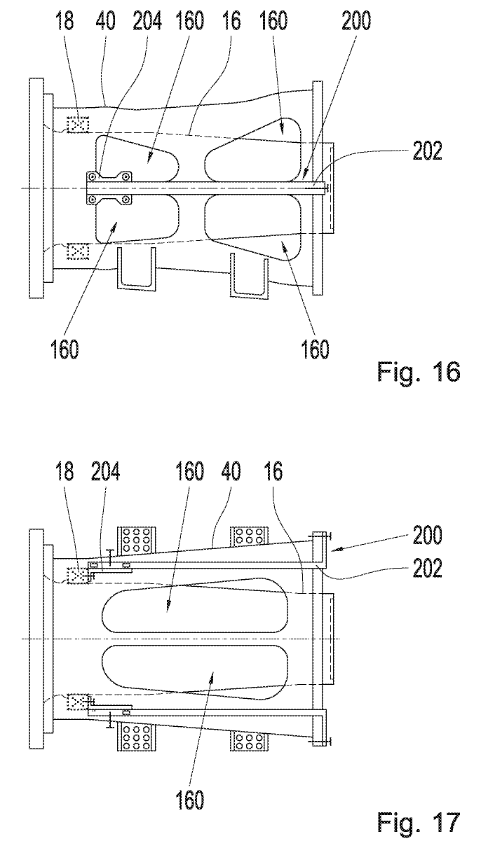

In yet further embodiments, the different configurations of through-openings 160 are combined. For example, the through-openings 160 of the third configuration according to FIG. 15 are provided on the upper side and the through-openings 160 of the second configuration according to FIG. 14 are provided laterally. Such a configuration is shown in FIGS. 16 through 18.

FIGS. 16 through 18 illustrate carriage assembly 200, which is mounted in rotor bearing housing 40. In an embodiment, carriage assembly 200 is mounted after the access opening of rotor bearing housing 40 is cleared. The first bearing is movable out of rotor bearing housing 40 by means of carriage assembly 200 during disassembly. The carriage assembly includes a guide rail 202, which is screwed to an end face of rotor bearing housing 40 on the outside thereof in the region of the access opening. In an embodiment, this may be done using screw holes at which other components, such as cover 50, are mounted in the operational state. Furthermore, the guide rail is screwed to rotor bearing housing 40 with one end region axially adjacent the seat of first bearing 18. This screw connection extends radially through the wall of rotor bearing housing 40. A carriage 204 is axially movably mounted on guide rail 202, here by means of rollers. First bearing 18 is attached to carriage 204 for removal thereof. During disassembly, carriage assembly 200 can move first bearing 18 out of rotor bearing housing 40. The attachment by means of a screw connection is shown in FIG. 17.

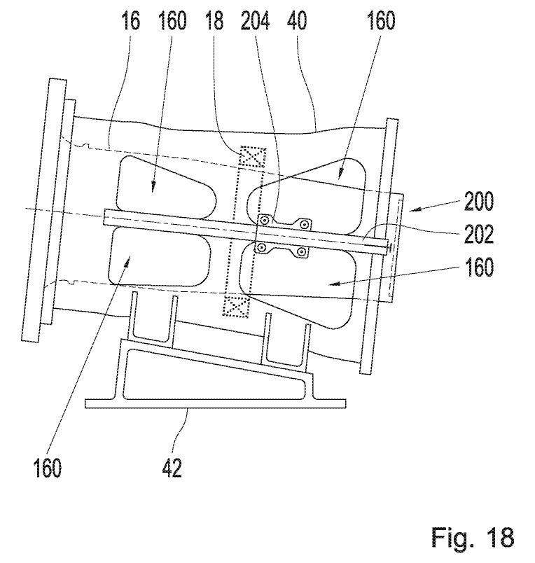

FIG. 18 illustrates how first bearing 18, held by carriage 204, was moved in a guided manner toward the access opening. During this process, the axis of rotation of rotor shaft 16, and thus also the orientation of guide rail 202, is inclined relative to a horizontal. Accordingly, gravity pulls first bearing 18 toward the access opening. Here, the movement is controlled by a brake and, alternatively or additionally, by an actuator. In the present case, carriage 204 is connected to the crane (not shown) of wind turbine 10, which is integrated in nacelle 20, so that no additional drives are required.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

10 wind turbine

12 rotor

14 hub

16 rotor shaft

18 first rolling-element bearing

20 nacelle

22 gearbox

24 generator

26 brake

28 tower

30 grid connection

38 second rolling-element bearing

40 rotor bearing housing

42 machine support structure

50 cover

52 input shaft

54 fixing element

56 further fixing element

58 arrow

60 arrow

62 non-rotating component

70 elastic connecting element

72 housing element

74 planetary gear set

76 rolling-element bearing

80 planet carrier

82 sun gear

84 ring gear

86 planet gears

90 bushing element

100 step

110 outer ring

112 screw

114 counter-bearing element

116 blind hole

118 nut

120 pulling device

122 further counter-bearing element

124 actuator

126 hook element

130 rolling element

132 inner ring

140 through-hole

150 region

160 through-opening

200 carriage assembly

202 guide rail

204 carriage

1. A mounting system for a drive train of a wind turbine on a nacelle of the wind turbine, the mounting system comprising:
a rotor bearing housing, the rotor bearing housing configured to be mounted to a machine support structure of the nacelle;
a stationary component; and
a first bearing, the first bearing being mounted in the rotor bearing housing for rotatably supporting a rotor shaft of the drive train,
wherein the mounting system is configured such that the rotor shaft is fixable to the stationary component for removal of the first bearing.

2. The mounting system as recited in claim 1,
wherein the stationary component is formed by the rotor bearing housing.

3. The mounting system as recited in claim 1,
wherein the rotor bearing housing has an access opening at an end opposite a rotor of the wind turbine, through which the first bearing is removable during disassembly.

4. The mounting system as recited in claim 3,
wherein the mounting system includes a second bearing which is removable through the access opening for removal thereof.

5. The mounting system as recited in claim 3,
wherein a radial clearance between the rotor shaft and the rotor bearing housing widens in an axial direction toward the end opposite the rotor.

6. The mounting system as recited in claim 1,
wherein the mounting system includes a carriage assembly which is mountable in the rotor bearing housing and which can be used to move the first bearing out of the rotor bearing housing during disassembly.

7. The mounting system as recited in claim 1,
wherein the mounting system is configured to release an outer ring of the first bearing from a seat in the rotor bearing housing by means of a screw.

8. The mounting system as recited in claim 1,
wherein the rotor bearing housing has at least one through-opening in a circumferential wall through which the first bearing is accessible for removal.

9. A wind turbine comprising a nacelle having a machine support structure, and further comprising:
a rotor shaft and a mounting system according to claim 1, the rotor bearing housing being mounted to the machine support structure, the rotor shaft being rotatably supported by the first bearing in the rotor bearing housing, and the rotor shaft being fixable to a stationary component for removal of the first bearing.

10. A method for removing a first bearing from a rotor bearing housing of a wind turbine, the rotor bearing housing being mounted to a machine support structure in a nacelle of the wind turbine, the first bearing being mounted in the rotor bearing housing, and a rotor shaft of the wind turbine being rotatably supported by the first bearing on the rotor bearing housing,
the method comprising:
fixing the rotor shaft to a stationary component;
releasing attachment of the first bearing after the rotor shaft has been fixed.
